(19) United States
(12) Patent Application Publication
(10) Pub. No.: US 2025/0165571 A1
(43) Pub. Date: May 22, 2025

(54) VIDEO VERIFICATION SYSTEMS WITH GENERATIVE ARTIFICIAL INTELLIGENCE

(71) Applicant: PayPal, Inc., San Jose, CA (US)

(72) Inventors: Amir ELTAHAN, Singapore (SG); Chun Kiat HO, Singapore (SG); Michael John ALELES, San Marcos, CA (US)

(21) Appl. No.: 18/517,290

(22) Filed: Nov. 22, 2023

(51) Int. Cl. G06F 21/32

(52) U.S. Cl. CPC G06F 21/32

(57) ABSTRACT

Systems, methods, and computer program products for a video verification system with generative artificial intelligence are provided. A generative artificial intelligence model generates a dynamic set of questions based on account, identity, risk, and compliance associated with a user. The questions in the set correspond to different difficulty levels for answering the question. A question from the set is communicated to a computing device of a user over a video call with an artificial intelligence bot. In response, the video verification system receives an answer to the question, and one or more of a telemetry, an audio, and a video. The answer, telemetry, audio, and video data are assessed to determine a difficultly level of a subsequent question. The subsequent question is selected from the dynamic set of questions using the difficulty level and provided to the computing device of a user over the video call.

### TECHNICAL FIELD

The disclosure generally relates to verification systems, and more specifically to using generative artificial intelligence in verification systems.

### BACKGROUND

Due to technological advancements and growing availability of graphics processing units (GPUs), generative artificial intelligence (AI) based fraud detection models are becoming widespread. Verification processes, including telephonic or video based applications, for verifying user identity during a verification process are also widespread. During the verification process, a telephone connection or a video call may be established between a user trying to access a system and a human agent tasked with verifying the identity of the user.

Conventionally, the users are verified in a variety of ways, including using knowledge based verification. However, with a widespread adoption of social networks combined with the users' willingness to share private data and AI's ability to scrape social networks, verification processes, including knowledge based verification, have become unreliable and easy to break during telephonic or video verification. This in turn can leave accounts exposed to being hacked and to a fraudulent takeover by unauthorized third parties.

Accordingly, conventional verification techniques that use knowledge based verification are no longer secure and are prone to errors.

### BRIEF DESCRIPTION OF THE DRAWINGS

FIG. 1 is an exemplary system where a video verification framework can be implemented.

FIG. 2 is a block diagram of a video verification framework, according to some embodiments.

FIGS. 3-4 are diagrams of a method for performing video verification with dynamically generated questions, according to some embodiments.

FIG. 5 is a block diagram of a computer system suitable for implementing one or more components or operations in FIGS. 1-4 according to an embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The embodiments are directed to a video verification framework. The video verification framework provides a know your customer (KYC) enhanced video verification using machine learning and generative artificial intelligence. The video verification framework may automatically unlock digital accounts, perform authentication for internal and external risk management, and verify sensitive data that a user or another party is attempting to access using a computing device. The video verification framework may also reduce telephone queues with human agent verification, provide secure access to accounts, reduce account opening time, provide for a faster onboarding process and the like. The video verification framework may also reduce fraud by minimizing the unauthorized third party access to the above.

The video verification framework verifies a user via a series of dynamically generated questions. The questions are based on dynamic and/or real-time data associated with a user account or information linked to the user account. The questions are communicated to a user over a video call with an artificial intelligence bot.

In some embodiments, the video verification framework may include a video verification system. The video verification system includes a video interface, an artificial intelligence bot, and a dialogue generator that authenticate a user. The video interface may create a video link, such as a video call, between a video interface of a computing device of a user and a video verification framework. During the video call, the video interface may display an artificial intelligence bot to a user. The artificial intelligence bot enters into a conversation with the user over the video interface. The dialogue generator may be a natural language processing model that may generate dialogue segments that the artificial bot may use to communicate with the user.

In some instances, the dialogue generator may include a generative AI model, such as a large language model (LLM). Additionally, the dialogue generator may generate a dynamic question or a set of questions that the artificial intelligence bot may incorporate into the dialogue segments and ask a user. The dynamic questions may be based on the information associated with the user or linked to a user account and that was collected over a predefined time interval. The information may include user identity data, payment data, compliance data, risk data, among others. This information may be based on user behavior and may change as the user behavior changes over a predefined time period, such as over a day, a week, a month, or several months. Accordingly, a dialogue generator may generate different dynamic questions at different points in time because the information associated with the user may be different. Additionally, the dialogue generator may dynamically generate questions that have various difficulty levels which may cause the video verification system to vary the difficulty levels of the questions based on the assessed user behavior.

Prior to and during the video call between a user and an artificial intelligence bot, the video verification system may collect data. This data may be telemetry data that may be captured using one or more sensors on or communicatively coupled to the computing device of a user. Example telemetry data may include location data, such as geographic or geo-location data, environment or surroundings data, user biometric data and the like. The data may also be audio data and video data. The audio data may include a dialogue that is occurring in real-time between a user and an artificial intelligence bot. The audio data may also include a question posed by an artificial intelligence bot and a user's answer to the question. The video data may include visual data that captures the video call between the user and the artificial intelligence bot, as well as the environment where the user is located as shown from a perspective of the computing device of the user. The video data may capture the user behavior over the video call as the user answers a question posed by the artificial intelligence bot or documents or images displayed to a camera of a computing device of a user during the video call.

In some embodiments, the video verification framework may include a data processing system, a sentiment assessment system, and a decision system. The data processing system may receive the telemetry data, audio data, and/or video data, and convert the data into vectors or other data that may be analyzed by the sentiment assessment system. The sentiment assessment system may receive the vectors and compare the vectors against one or more policies and rules to identify the sentiment of the user. The policies may determine whether the answer to the question was correct, whether a user is located where the user claims to be, whether a user in a video is a real human or a deep fake generated by AI, among others. Based on the sentiment, the sentiment assessment system may generate a score. The score may correspond to a difficulty level of a question. The decision system may receive the score and associate a score with a difficulty level of a subsequent question, or use the score to determine whether user authentication succeeded or failed.

The dialogue generator may receive the difficulty level of the question and select a subsequent question that corresponds to the difficulty level. Alternatively, the dialogue generator may generate a question corresponding to the difficulty level using the user information, such as identity data, payment data, compliance data, risk data, and the like. The dialogue generator may then incorporate the question into the dialogue segment for the artificial intelligence bot to pose to the user over a video call. The cycle may continue with the dialogue generator generating questions having various difficulty levels until the video verification system authenticates or fails to authenticate the user.

Further embodiments of the video verification framework are discussed below.

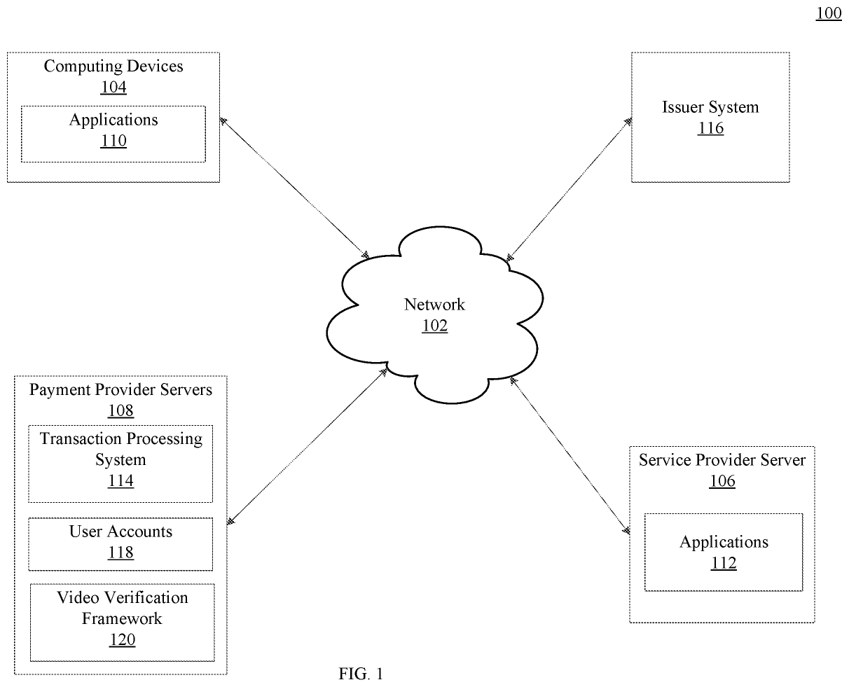

FIG. 1 is an exemplary system 100 where embodiments can be implemented. System 100 may be a computing environment or a computing system. System 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various components that are accessible to network 102 may be computing device(s) 104, service provider server(s) 106, and payment provider server(s) 108. Computing devices 104 may be portable and non-portable electronic devices under the control of a user and configured to transmit, receive, and manipulate data from service provider server(s) 106 and payment provider server(s) 108 over network 102. Example computing devices 104 include desktop computers, laptop computers, tablets, smartphones, wearable computing devices, eyeglasses that incorporate computing devices, implantable computing devices, etc.

Computing devices 104 may include one or more applications 110. Applications 110 may be pre-installed on the computing devices 104, installed on the computing devices 104 using portable memory storage devices, such as compact disks or thumb-drives, or be downloaded to the computing devices 104 from service provider server(s) 106 and/or payment provider server(s) 108. Applications 110 may execute on computing devices 104 and receive instructions and data from a user, from service provider server(s) 106, and payment provider server(s) 108.

Example applications 110 may be payment transaction applications. Payment transaction applications may be configured to transfer money world-wide, receive payments for goods and services, manage money spending, etc. Further, applications 110 may be under an ownership or control of a payment service provider, such as PAYPAL®, Inc. of San Jose, CA, USA, a telephonic service provider, a social networking service provider, and/or other service providers. Applications 110 may also be analytics applications. Analytics applications perform business logic, provide services, and measure and improve performance of services and functions of other applications that execute on computing devices 104 based on current and historical data. Applications 110 may also be security applications for implementing client-side security features, programmatic client applications for interfacing with appropriate application programming interfaces (APIs) over network 102, communication applications, such as email, texting, voice, and instant messaging applications that allow a user to send and receive emails, calls, texts, and other notifications through network 102, and the like. Applications 110 may be location detection applications, such as a mapping, compass, and/or global positioning system (GPS) applications, social networking applications and/or merchant applications. Additionally, applications 110 may be service applications that permit a user of computing device 104 to receive, request and/or view information for products and/or services, and also permit the user to purchase the selected products and/or services.

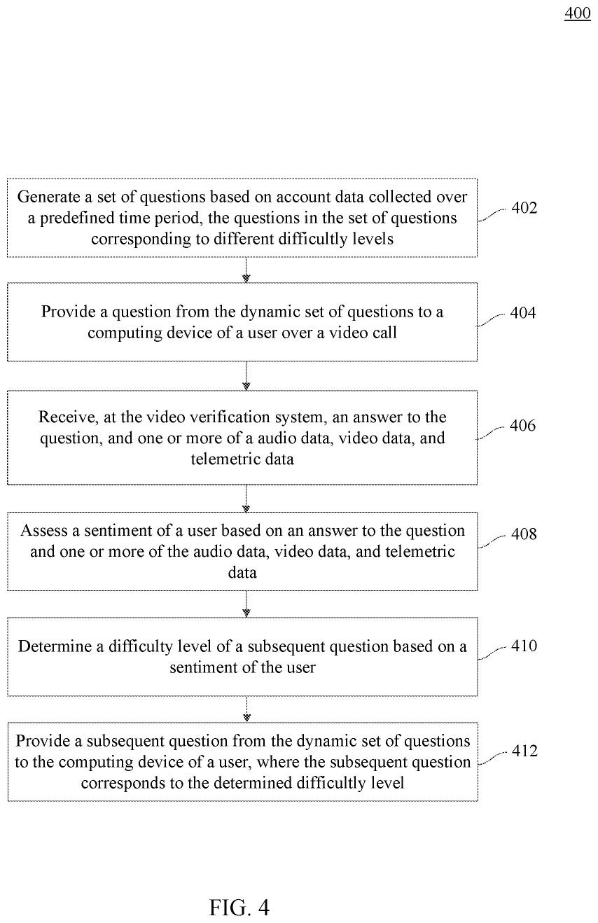

In an embodiment, applications 110 may utilize numerous components included in computing device 104 to receive input, store and display data, and communicate with network 102. Example components are discussed in detail in FIG. 4.

As discussed above, one or more service provider servers 106 may be connected to network 102. Service provider server 106 may also be maintained by a service provider, such as PAYPAL®, a telephonic service provider, social networking service, and/or other service providers. Service provider server 106 may be software that executes on a computing device configured for large scale processing and that provides functionality to other computer programs, such as applications 110 and applications 112 discussed below.

In an embodiment, service provider server 106 may initiate and direct execution of applications 112. Applications 112 may be counterparts to applications 110 executing on computing devices 104 and may process transactions at the requests of applications 110. For example, applications 112 may be financial services applications configured to transfer money world-wide, receive payments for goods and services, manage money spending, etc., that receive message from the financial services applications executing on computing device 104. Applications 112 may be security applications configured to implement client-side security features or programmatic client applications for interfacing with appropriate application programming interfaces (APIs) over network 102. Applications 112 may be communication applications that perform email, texting, voice, and instant messaging functions that allow a user to send and receive emails, calls, texts, and other notifications over network 102. In yet another embodiment, applications 112 may be location detection applications, such as a mapping, compass, and/or GPS applications. In yet another embodiment, applications 112 may also be incorporated into social networking applications and/or merchant applications.

In an embodiment, applications 110 and applications 112 may process transactions on behalf of a user. In some embodiments, to process transactions, applications 110, 112 may request payments for processing the transactions via payment provider server(s) 108. For instance, payment provider server 108 may be a software application that is configured to receive requests from applications 110, 112 that cause the payment provider server 108 to transfer funds of a user using application 110 to service provider associated with application 112. Thus, applications 110 and 112 may receive user data, including user authentication data, for processing any number of electronic transactions, such as through payment provider server 108.

In an embodiment, payment provider servers 108 may be maintained by a payment provider, such as PAYPAL®. Other payment provider servers 108 may be maintained by or include a merchant, financial services provider, credit card provider, bank, and/or other payment provider, which may provide user account services and/or payment services to a user. Although payment provider servers 108 are described as separate from service provider server 106, it is understood that one or more of payment provider servers 108 may include services offered by service provider server 106 and vice versa.

Each payment provider server 108 may include a transaction processing system 114. Transaction processing system 114 may correspond to processes, procedures, and/or applications executable by a hardware processor. In an embodiment, transaction processing system 114 may be configured to receive information from one or more applications 110 executing on computing devices 104 and/or applications 112 executing on service provider server 106 for processing and completion of financial transactions. Financial transactions may include financial information corresponding to user debit/credit card information, checking account information, a user account (e.g., payment account with a payment provider server 108), or other payment information. Transaction processing system 114 may complete the financial transaction for the purchase request by providing payment to application 112 executing on service provider server 106. For example, transaction processing system 114 may communicate with one or more issuer systems 116, such as credit card, debit card, and/or bank systems, to provide payment for the transaction to application 112 executing on service provider server 106.

Payment provider server 108 may also include user accounts 118. Each user account 118 may be established by one or more users using applications 110 with payment provider server 108 to facilitate payment for goods and/or services offered by applications 112. User accounts 118 may include or be linked to user identity data, payment data, compliance data, and/or risk data. Identity data may be a user name, address, birthdate, biometric data, user location data, and the like. Payment data may be transactions that are linked to the user account, user's payment information, including credit card, debit card, bank information, computing device 104 used to conduct transactions, merchant information, location of the merchant, and the like. Compliance data may include data, including documents, that the user submitted to payment processing server 108 for compliance purposes. Risk data may be data that the user submitted to payment processing server 108 to identify risk of a user completing transactions, user credit history score, the number of times user accounts 118 of a user are accessed from different computing devices, locations of the transactions, correspondence between the location of the transactions and computing device 104 of a user, and the like. Risk data may also be risk assessment data computed at a time of a transaction or verification, or risk assessment data that is dynamically generated and associated with a user based on user activity, e.g., multiple transactions or verifications that occur over a predefined period.

Payment provider servers 108 may also include a video verification framework 120. Video verification framework 120 may execute on payment processing server 108 or a combination of one or more servers connected to network 102. Video verification framework 120 may establish a video connection, such as a video call, over network 102 with computing device 104 of a user, e.g., computing device 104 that executes applications 110 to conduct transactions. Video verification framework 120 may use the video call to authenticate the user to payment provider servers 108 or service provider server 106. In particular, video verification framework 120 may use a generative artificial intelligence bot to communicate with a user during a video call, and use generative AI to generate, in real time, a question or a series of questions to ask a user during the video call. In some embodiments, each question may correspond to a difficulty level. In this way, the video verification framework 120 may select a question with a higher or lower difficulty level by assessing the user behavior during the video call. For example, if a user has a difficulty answering a question or is exhibiting fraudulent like behavior, the video verification system may follow up with a more difficult question. Additionally, the questions may be dynamic and incorporate user account information, such as identity data, payment data, compliance data, and/or risk data collected over a predefined time period and associated with the user account 118.

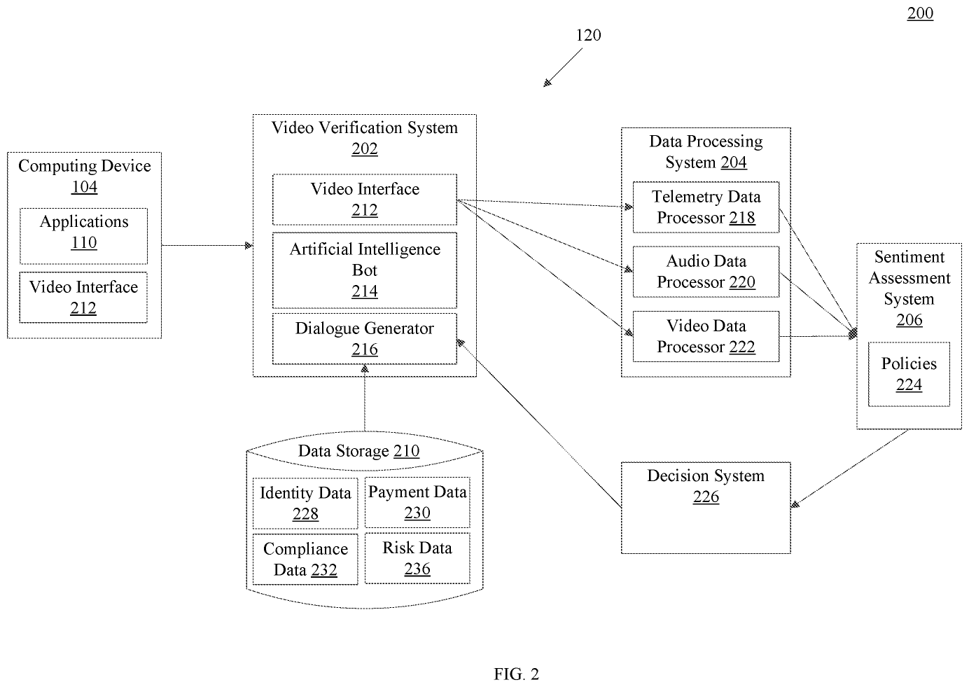

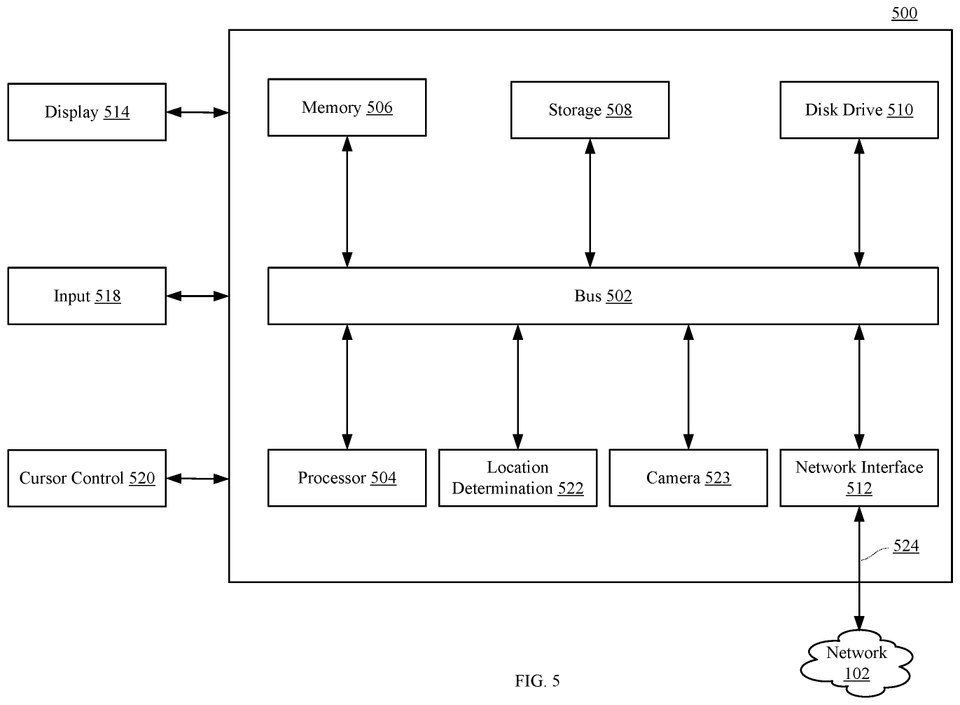

FIG. 2 is a block diagram 200 of a video verification framework 120, according to some embodiments. Video verification framework 120 may operate using hardware, software, or a combination thereof, and may operate using one or more computer devices, such as the one discussed in FIG. 5. Video verification framework 120 may establish a video connection with a user and use an artificial intelligence bot and generative AI to authenticate the user over the video connection in real-time. For example, artificial intelligence bot may enter into a dialogue with a user over a video interface and ask the user one or more questions that may authenticate the user. The dialogue may be generated by generative AI and may include dynamic questions that are based on user account data, including an account history of the user, documents of a user provided to video verification system 202, location of computing device (e.g., determined using a location of the Internet Protocol address, GPS, or triangulation techniques), and the like.

Video verification framework 120 may also vary a number and difficulty level of questions that artificial intelligence bot asks a user. The number and difficulty level may depend on video verification framework 120 assessing user behavior, which May cause the number and difficulty level of questions to increase or decrease. The video verification framework 120 may continue to pose questions until video verification framework 120 authenticates the user or determines that the authentication failed.

In some embodiments, video verification framework 120 may include a video verification system 202, a data processing system 204, a sentiment assessment system 206, a decision system 226, and a data storage 210.

In some embodiments, video verification system 202 may include a video interface 212, an artificial intelligence bot 214, and a dialogue generator 216. Video interface 212 may be software that may execute and establish a video connection, such as a video call, between video verification system 202 and computing device 104 of a user. Computing device 104 of a user may also include video interface 212 that may execute on computing device 104. Video interface 212 may be downloaded onto video verification system 202, and/or computing device 104, be accessible using a hyperlink circulated from video verification system 202 to computing device 104, may be activated by or accessible to application 110 of computing device 104, or the like.

The video interface 212 may request permissions to transmit and receive data to and from computing device 104. The data may include telemetry data, audio data, and video data, in some embodiments. Telemetry data may be data received from sensors included or coupled to computing device 104. Example telemetry data may include a location of computing device 104 as determined by computing device 104, accelerometer data, battery data, network connectivity and usage data, biometric data sensed using biometric sensors, digital pictures or video taken by a camera of computing device 104, and the like. Telemetry data may also include data from a keyboard, mouse, or another input device that a user may use to answer the questions. Video data may include video data received by video interface 212 of video verification system 202. Example video data may be a video of a user interacting with artificial intelligence bot over video interfaces 212 of video verification system 202 and computing device 104. Video data may also include a video of a document that computing device 104 uploaded to video verification system 202 during or prior to video verification or a video taken using a camera of computing device 104. Audio data may be audio received by video interface 212 and may include an audio recording to a dialogue between the artificial intelligence bot and the user over video interfaces 212, an audio of the questions that the artificial intelligence bot posed to the user, and an audio of the user answering the questions.

Artificial intelligence bot 214 may be software or a combination of software and hardware that may interact with a user over video interface 212. The software may generate artificial intelligence bot 214 in a human like image, a hologram, or any other type of an entity that may enter into a dialogue with a user of computing device 104.

Dialogue generator 216 may generate dialogue segments, dialogue turns, etc., that artificial intelligence bot 214 may communicate to a user as part of a dialogue or conversation between the artificial intelligence bot 214 and the user. The dialogue segments may incorporate questions that video verification framework 120 may use to verify or authenticate the user. Dialogue generator 216 may include one or more natural language processing models, large language models, generative pre-trained transformer (GPT) models, and the like to generate text or audio that simulates a conversation in a natural language.

Dialogue generator 216 may select or generate a question or a set of questions that dialogue generator 216 may to incorporate into a conversation with a user over video interface 212. As part of the conversation, the user may answer the question or a set of questions. In some instances, dialogue generator 216 may select or generate a question that corresponds to a difficulty level, with different questions having different difficultly levels. The difficultly level may be based on the assessment of the user behavior based on the telemetry data, audio data, and video data received at video verification system 202 during a video call. The difficulty level of subsequent questions may also increase or decrease based on the assessment.

The questions may be dynamic and may vary with time. For example, the questions may be based on the data stored in data storage 210, such as identity data 228, payment data 230, compliance data 232, and/or risk data 236 among few examples. For example, dialogue generator 216 may receive payment data 230 that occurred over a predefined time interval, such as a previous month, and generate a question such as “What store have you shopped in last week?”, “Which day of the week do you shop?”, “What is the brand of a credit card do you use for payment?”, “Did you apply a coupon last time you shopped at this store?”. Dialogue generator 216 may also receive identity data 228 and generate a question such as “How far is the store that you shop in from where you live?,” “How many accounts do you have?,” and the like.

In some instances, identity data 228, payment data 230, compliance data 232, and/or risk data 236 that dialogue generator 216 may use to generate questions may be collected over a predefined time period and updated in real time. In this way, the questions and the answers to the questions are dynamic in nature. That is the questions and answers may vary over different time periods based on the user activity. For example, an answer to a question “What store have you shopped in last week?” may change from week to week.

As discussed above, dialogue generator 216 may generate a question or a set of questions and associate the question or the set of questions with difficultly levels. For example, a question “What store have you shopped in last week?” may have a lower difficulty level than the question “Which day of the week do you shop?”. Dialogue generator 216 may include a neural network model that may use reinforcement learning or be trained using a labeled training dataset with questions and difficulty levels to learn to associate questions with different difficultly levels.

In some instances, dialogue generator 216 may generate a first question at a predefined difficultly level, and vary the difficultly of subsequent questions. Alternatively, dialogue generator 216 may generate a first question based on the one or more of the telemetry data, video data, and audio data collected by video verification system 202.

In some embodiments, video verification system 202 may collect the telemetry data, video data, and audio data collected during the video call and pass the data to data processing system 204. The data may be collected over the entire video call, collected when the artificial intelligence bot 214 poses a question and receives the answer in the dialogue segments, or only when the user provides the dialogue segment with the answer. The data collection interval may vary with the network 102 bandwidth or with the types of computing devices 104 that may be used during a video call.

Data processing system 204 may include a telemetry data processor 218, an audio data processor 220, and a video data processor 222. Telemetry data processor 218, audio data processor 220, and video data processor 222 may be software and or hardware and may operate as a single or multiple processors.

Telemetry data processor 218 may receive, parse and standardize the telemetry data. Telemetry data processor 218 may also log changes in the telemetry data during the video call. In some instances, telemetry data processor 218 may generate a vector that includes parameters that correspond to the parsed and standardized telemetry data in a format consisted with the format received and processed by sentiment assessment system 206. The parameters may include location of computing device 104, user biometric data, and the like.

Audio data processor 220 may process audio data from the video verification system 202. In some instances, audio data processor 220 may convert a dialogue included in audio data into text data, such as one or more words, using a speech-to-text processor. From the text data, audio data processor 220 may use natural language processing to understand the meaning of the words, such as, to identify a question in the audio data posed by the video verification system 202 and an answer to a question provided by a user over the video call. In some instances, audio data processor 220 may also generate vectors that include various parameters. Example parameters may correspond to a question, an answer, a tone of voice that the user used to answer the question (which may indicate that a user is confident, is lying, or is nervous), whether the voice of a user in the audio corresponds to a known voice of a user (e.g., the voice previously recorded and saved during an account and system set-up), and the like. The audio data processor 220 may also remove unnecessary or filler words from the audio data, such as “um,” “the,” “an,” “and,” and the like. In some embodiments, the vector may be in a format consistent with the format received and processed by sentiment assessment system 206.

Video data processor 222 may receive video data from the video verification system 202. Video data processor 222 may use or more neural networks or other software trained to process video data. For example, video data processor 222 may determine pixel density at the edges of the video to determine whether a video is smoothed out and is therefore not genuine. Video data processor 222 may also determine whether the video does or does not match a video type that a camera of computing device 104 would output. Video data processor 222 may also determine whether a video of a document is genuine or not by analyzing the paper, signature and the like. Video data processor 222 may determine whether video data includes a video is of a real person, and not a video of a computer generated person or a superimposed person, whether the answers that a user provided are truthful by examining user behavior in the video. For example, a video of a user looking up or down when answering a question and not looking at the video interface 212 may indicate fraudulent behavior. In some instances, video data processor 222 may generate one or more vectors that include parameters, and format the results of the above analytics into the vectors. In some embodiments, the vector may be in a format consisted with the format received and processed by sentiment assessment system 206.

In some embodiments, sentiment assessment system 206 may receive the data, such as vectors from telemetry data processor 218, audio data processor 220, and video data processor 222. Sentiment assessment system 206 may use the data to determine a sentiment of a user conducting a video call with video verification system 202. In some instances, sentiment assessment system 206 may include one or more policies 224. Policies 224 may be specific to a user, specific to computing device 104 associated with the user, or may be applied to any user. Sentiment assessment system 206 may compare parameters in one or more vectors to one or more rules in policies 224 to determine a sentiment of the user. Sentiment of a user is a probability whether the user is a genuine user or a fraudulent user, of whether video verification system 202 should trigger a heightened scrutiny of the user.

In some instances, sentiment assessment system 206 may use a vector to determine whether an answer of a user to a question posed by an artificial intelligence bot 214 is correct. The correct answer may be stored in data storage 210 and retrieved on-demand. For example, for question “What store have you shopped in last week?”, sentiment assessment system 206 may compare the answer in the vector to an answer generated based on payment data 230 associated with the user.

In other instances, sentiment assessment system 206 may use parameters in one or more vectors to determine whether the location of computing device 104 of the user as indicated by the telemetry data is the same as the location in the vector indicated by the answer of the user or shown in video data.

In yet other instances, sentiment assessment system 206 may use the parameters in the one or more vectors to determine whether the video data showing a user indicates that a user is genuine user and not artificial intelligence image of the user. Sentiment assessment system 206 may use the parameters in the vectors to determine whether the video data showing the user matches an image of the user previously submitted and stored in data storage 210, or whether the image of the user was smoothed which indicates a fraudulent image.

Notably the examples above are not limiting, as policies 224 may include other rules that may compare and processes the parameters in the vectors to determine the sentiment of the user.

In some instances, sentiment assessment system 206 may generate a sentiment for every rule in the policies 224, and then combine the sentiments. In other instances, sentiment assessment system 206 may generate one sentiment based on multiple rules in policies 224. In yet other instances, sentiment assessment system 206 may determine that if the parameters in one or more vectors failed one or more of the selected rules, the verification has failed or requires heightened scrutiny.

Once sentiment assessment system 206 generates a sentiment, sentiment assessment system may convert a sentiment to a score. Sentiment assessment system 206 may transmit the score to decision system 226.

Decision system 226 may receive a score associated with the sentiment of the user. Based on the score, the decision system 226 may determine that the user is verified, that the user has failed verification, or the artificial intelligence bot 214 should continue a dialogue with the user and ask additional questions having an increased, same, or decreased difficulty level. If the user is verified, decision system 226 may transmit a message to video verification system 202 to complete the video call. Video verification system 202 may then complete the video call and perform an action subject to verification. An example verification action may be a message to unlock a user account, a message that the user was authenticated for internal risk management, or authenticated to access sensitive information. If the user is not verified, decision system 226 may transmit a message to video verification system 202 to complete the video call without taking further verification action. In this case, dialogue generator 216 may generate a dialogue segment that the user failed verification, which is communicated to the user over video interface 212 via artificial intelligence bot 214. If the decision system 226 indicates that video verification system 202 should ask a subsequent question, decision system 226 may also determine the difficultly level of the question. The difficultly level of the question may depend on a score. For example, decision system 226 may map the score to a range of values, where the range corresponds to a particular difficulty level. The decision system 226 may generate a message to dialogue generator 216 to generate a dialogue segment that includes a question with a corresponding difficulty level.

Once dialogue generator 216 receives a message from decision system 226 to generate a dialogue segment that includes a question with a corresponding difficultly level, dialogue generator 216 may generate the question using data from data storage 210. Alternatively, dialogue generator 216 may have already generated a set of questions, where the questions in the set correspond to different difficulty levels. In this case, dialogue generator 216 may select one of the questions in the set that corresponds to the difficulty level in the message, and generate a dialogue segment that includes the selected question. If the set of questions does not include a question with the corresponding difficulty level, or if the dialogue generator 216 has already included all questions with the corresponding difficulty level in the dialogue, dialogue generator 216 may then generate a new question and include the question in the dialogue segment. Once the dialogue generator 216 generates a dialogue segment that includes the question, the artificial intelligence bot 214 may communicate the dialogue segment to the user over video interface 212 as part of the dialogue. As the video interface 212 receives an answer from the user, the answer is processed as discussed above.

In this way, video verification system 202 may vary the difficulty of the subsequent questions, e.g., increase or decrease the difficulty level of the subsequent questions based on the sentiment of a user as determined from a dialogue between the user and the artificial intelligence bot. Further, because the questions are dynamically generated based on data collected over a predefined time period, the questions may be dynamic in nature and reflect user behavior during the predefined time period.

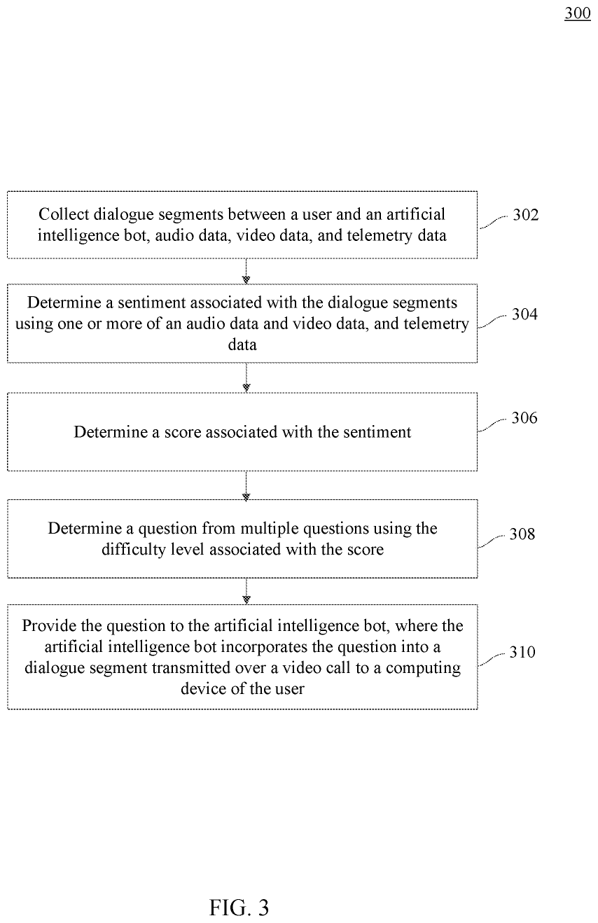

FIG. 3 is a flowchart of a method 300 for performing video verification with dynamically generated questions, according to an embodiment. Method 300 may be performed using hardware and/or software components described in FIGS. 1-2. Note that one or more of the operations may be deleted, combined, or performed in a different order as appropriate.

At operation 302, dialogue segments between a user and an artificial intelligence bot, audio data, video data, and telemetry data are collected. At operation 302, video verification system 202 has already established a video call between video interface 212 of video verification system 202 and video interface 212 of computing device 104 of a user. During the video call, a user and artificial intelligence bot 214 enter into a conversation or dialogue, where both the user and artificial intelligence both 214 converse in dialogue segments. As part of the dialogue, artificial intelligence bot 214 poses a question to a user in a dialogue segment transmitted over video interfaces 212. In response, the video interface 212 of computing device 104 of a user transmits a dialogue segment that includes an answer to the question. During the video call, video verification system 202 collects the audio and video data associated with the dialogue segments and telemetry data.

At operation 304, a sentiment of a user is determined from the audio data and video data associated with the dialogue segments, and the telemetry data. As discussed above, data processing system 204 may convert the audio, video, and telemetry data into vectors with parameters include analytics associated with the dialogue segments and telemetry data. The vectors may include parameters that include a question, an answer to the question, user location, an indication whether a user is a genuine user or an artificially generated replication of a user, indications of genuine or fraudulent user behavior and the like. The sentiment assessment system 206 may receive the vectors and analyze the vectors using policies 224 that include one or more rules. The policies 224 may include rules that determine whether the location indicated by the user matches the location of computing device 104, whether the answer provided by the user correctly answers the question, and the like. By applying policies 224 to the vectors, sentiment assessment system 206 may determine the sentiment of the user.

At operation 306, a score associated with the sentiment is determined. As discussed above, sentiment assessment system 206 may map the sentiment to a score. Decision system 226 may use the score to determine that the user is verified, that the user has failed verification, or the artificial intelligence bot 214 should continue a dialogue with the user and ask additional questions.

At operation 308, a subsequent question from a set of question is determined. For example, if decision system 226 determines that the user is verified or not verified, decision system 226 may transmit a message to video verification system 202 to complete the video call and method 300 ends (not shown). Decision system 226 may also use the score to determine to generate a subsequent question, and then map the score to the difficulty level. Decision system 226 may then transmit the difficulty level to dialogue generator 216 that may use the difficulty level to select a subsequent question from the list of previously generated questions. As discussed above, the list of previously generated questions may be based on identity data 228, payment data 230, compliance data 232 and/or risk data 236 associated with the user and collected over a predefined time period. In this way, the questions are dynamic and may change as user behavior changes over the predefined time period. Alternatively dialogue generator may generate a subsequent question with a corresponding difficulty level using identity data 228, payment data 230, compliance data 232 and/or risk data 236 associated with the user.

At operation 310, a subsequent question is provided to the artificial intelligence bot as part of the dialogue segment. For example, dialogue generator 216 may generate a dialogue segment that includes the question. Once generated, artificial intelligence bot 214 may communicate the question to the user over video interface 212.

At completion of operation 310, method 300 may revert to operation 302 to detect the sentiment of a user for a subsequent question. Method 300 may repeat iteratively until a user is either verified or fails verification over a video call. Further, the difficultly of the questions may vary with each iteration depending on whether the sentiment of the user causes the difficulty score to fluctuate which may result in an increase or decrease of a difficulty of the questions posed to the user.

FIG. 4 is a flowchart of a method 400 for performing video verification with dynamically generated questions, according to an embodiment. Method 400 may be performed using hardware and/or software components described in FIGS. 1-2. Note that one or more of the operations may be deleted, combined, or performed in a different order as appropriate.

At operation 402, a set of questions is generated based on data associated with the user account. For example, dialogue generator 216 may generate a set of questions. Each question in the set of questions may correspond to a different difficulty level for answering the question. The questions in the set of questions may be based on identity data 228, payment data 230, compliance data 232 and/or risk data 236 associated with the user and collected over a predefined time interval, such as a day, a week, a month, etc. The predefined time interval may be dynamic and may shift with the passage of time, causing the answers to the same question to vary over different time intervals. For example, an answer to the question “Where do you buy your groceries?” may be different over different time periods. In some instances, the set of questions may include a question with a default or neutral difficulty level which may be a first question that dialogue generator 216 may incorporate into a dialogue segment for artificial intelligence bot 214 to a user.

At operation 404, a question in the set of questions is provided to a computing device of a user over a video call. For example, dialogue generator 216 may select a question in the set of questions to include in a dialogue segment. The question may be a default question or a question that corresponds to a difficulty level that dialogue generator 216 received from decision system 226. The dialogue segment that includes the question may be provided to artificial intelligence bot 214 to be communicated to computing device 104 of a user during a video call over video interface 212.

At operation 406, an answer to the question, audio data, video data, and telemetry data are received at the video verification system. For example, video interface 212 of video verification system 202 may receive a dialogue segment from computing device 104 of a user that includes an answer to the question. The dialogue segment may be included in the audio data and/or video data that video interface 212 of video verification system 202 receives from video interface 212 of computing device 104. Additionally, video verification system 202 receives telemetry data from one or more sensors of computing device 104 via video interface 212 or via another communication channel.

At operation 408, a sentiment of a user is assessed based on an answer to the question, telemetry data, video data, and audio data. For example, Data processing system 204 may receive the dialogue segment that includes the answer as part of the video data and audio data communicated over the video call. Data processing system 204 may convert audio data and video data into one or more vectors. The vectors may include an answer to the question and analytics that are based on video and audio data as discussed above. Data processing system 204 may also extract and analyze telemetry data, such as location data of the computing device 104, and user biometrics and format the analyzed telemetry data into a vector. Sentiment assessment system 208 may apply one or more policies 224 to the vectors and the analyzed telemetry data to determine the sentiment of the user. In some instances, the score may be based on whether the answer is a correct answer to the question, as well as other parameters in the vectors.

At operation 410, a difficulty level of the question is determined from the sentiment. For example, sentiment assessment system 208 may map the sentiment of a user to a score. Decision system 226 may then map the score to a difficulty level.

At operation 412, a subsequent question is provided to the video verification system. For example, dialogue generator 216 may receive the difficulty level from the decision system 226 and select a subsequent question from the set of questions with the received difficulty level. If the subsequent question does not exist, dialogue generator 216 may generate the subsequent question that has a received difficulty level. Notably, the difficulty level of the subsequent question may be different from the preceding question or initial question that artificial intelligence bot 214 posed to a user over video call and may vary with the user's responses to the preceding questions.

After operation 412, method 400 may proceed to operation 402. Method 400 may repeat iteratively until a user is authenticated or fails authentication.

Although the embodiments discussed above are directed to video verification, the embodiments may also apply to other types of verification, including telephone based verification or another type of audio verification, or text based verification, including question-answer verification over an email, text, or another medium. In the telephone and text based verifications, the embodiments may verify a user as discussed above but without the video component. In other embodiments, the video component may be activated or suggested based on the user responses to the questions posed by artificial intelligence bot 214.

In accordance with various embodiments of the disclosure, computer system 1000, such as a computer and/or a server, includes a bus 502 or other communication mechanism for communicating information, which interconnects subsystems and components, such as a processing component 504 (e.g., processor, micro-controller, digital signal processor (DSP), graphics processing unit (GPU), etc.), a system memory component 506 (e.g., RAM), a static storage component 508 (e.g., ROM), a disk drive component 1010 (e.g., magnetic or optical), a network interface component 512 (e.g., modem or Ethernet card), a display component 514 (e.g., CRT or LCD), an input component 518 (e.g., keyboard, keypad, or virtual keyboard), a cursor control component 520 (e.g., mouse, pointer, or trackball), a location determination component 522 (e.g., a Global Positioning System (GPS) device as illustrated, a cell tower triangulation device, and/or a variety of other location determination devices known in the art), and/or a camera component 523. In one implementation, the disk drive component 510 may comprise a database having one or more disk drive components.

In accordance with embodiments of the disclosure, the computer system 500 performs specific operations by the processor 504 executing one or more sequences of instructions contained in the memory component 506, such as described herein with respect to the mobile communications devices, mobile devices, and/or servers. Such instructions may be read into the system memory component 506 from another computer readable medium, such as the static storage component 508 or the disk drive component 510. In other embodiments, hard-wired circuitry may be used in place of or in combination with software instructions to implement the disclosure.

Logic may be encoded in a computer readable medium, which may refer to any medium that participates in providing instructions to the processor 504 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 510, volatile media includes dynamic memory, such as the system memory component 506, and transmission media includes coaxial cables, copper wire, and fiber optics, including wires that comprise the bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 500. In various other embodiments of the disclosure, a plurality of the computer systems 500 coupled by a communication link 524 to the network 502 (e.g., such as a LAN, WLAN, PTSN, and/or various other wired or wireless networks, including telecommunications, mobile, and cellular phone networks) may perform instruction sequences to practice the disclosure in coordination with one another.

The computer system 500 may transmit and receive messages, data, information and instructions, including one or more programs (i.e., application code) through the communication link 524 and the network interface component 512. The network interface component 512 may include an antenna, either separate or integrated, to enable transmission and reception via the communication link 524. Received program code may be executed by processor 504 as received and/or stored in disk drive component 510 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A video verification system comprising:
a memory; and
one or more hardware processors coupled to a non-transitory memory and configured to read instructions from the non-transitory memory to cause the video verification system to perform operations comprising:
generating a dynamic set of questions based on account data associated with a user, wherein questions in the dynamic set of questions correspond to different difficulty levels;
providing a question in the dynamic set of questions to the video verification system;
receiving, at the video verification system an answer to the question, and one or more of a telemetry data, an audio data, and a video data;
assessing the answer to the question, and one or more of the telemetry data, the audio data, and the video data to determine a difficultly level of a subsequent question; and
providing the subsequent question from the dynamic set of questions that corresponds to the difficultly level to the video verification system.

2. The video verification system of claim 1, wherein the operations further comprise:
generating, using a visual artificial intelligence bot of the video verification system, a segment in a dialogue, wherein the segment in the dialogue incorporates the question;
communicating, using the visual artificial intelligence bot, the segment in the dialogue to the user during a video call.

3. The video verification system of claim 2, wherein the operations further comprise:
collecting one or more of the telemetry data, the audio data, and the video data during a predefined time interval after communicating the segment in the dialogue incorporating the question to the user.

4. The video verification system of claim 2, wherein the operations further comprise:
collecting one or more of the telemetry data, the audio data, and the video data during a predefined time interval before and after the communicating the segment in the dialogue incorporating the question to the user.

5. The video verification system of claim 1, wherein the operations further comprise:
determining the dynamic set of questions does not include the subsequent question corresponding to the difficulty level; and
generating the subsequent question with the determined difficulty level during a video call with an artificial intelligence bot.

6. The video verification system of claim 1, wherein the operations further comprise:
determining that the answer to the question is a correct answer;
determining a sentiment of the user using the one or more of the audio data, the video data, and the telemetry data during a video call with an artificial intelligence bot; and
determining the difficultly level of the subsequent question based on the correct answer and the sentiment.

7. The video verification system of claim 6, wherein the sentiment of the user corresponds to a score, and to determine the difficulty level of the subsequent question, the operations further comprise:
mapping the score to the difficulty level of the subsequent question.

8. The video verification system of claim 1, wherein the data associated with the user corresponds to account data of the user collected during a predefined time period.

9. A method comprising:
collecting a segment of a dialogue between a user and an artificial intelligence bot and telemetry data, wherein the segment of the dialogue comprises one or more of a video data and an audio data;
determining a sentiment associated with the segment of the dialogue using the one or more of the video data, the audio data, and the telemetry data;
determining a score associated with the sentiment, wherein the score corresponds to a difficulty level of a question;
determining the question using the difficulty level and data of the user; and
providing the question to the artificial intelligence bot, wherein the artificial intelligence bot incorporates the question into a second segment of the dialogue that the artificial intelligence bot communicates to the user.

10. The method of claim 9, further comprising:
conducting the dialogue between the user and the artificial intelligence bot over a visual interface and as part of a verification process that verifies the user to a computing system that stores confidential information associated with the user.

11. The method of claim 9, wherein the telemetry data comprises data associated with a computing device that receives a user communication of the segment of the dialogue, the telemetry data including a location of the computing device; and
wherein determining the sentiment is based on the user communication and the location of the computing device.

12. The method of claim 9, wherein determining the question is based on a user account information associated with the user participating in the dialogue with the artificial intelligence bot.

13. The method of claim 9, further comprising:
receiving a third segment of the dialogue between the user and the artificial intelligence bot and a second telemetry data, the third segment of the dialogue comprising one or more of a second video data and a second audio data;
determining an answer to the question from the audio data;
determining a second sentiment of the user associated with the third segment of the dialogue based on one or more of the second audio data, the second video data and the second telemetry data;
determining to increase or decrease the difficulty level using the answer and the second sentiment; and
generating a second question based on the increased or decreased difficultly level.

14. The method of claim 9, wherein the video data is collected during a video call between the user and the artificial intelligence bot.

15. The method of claim 14, further comprising:
communicating the question to the user in the dialogue during the video call.

16. A non-transitory computer readable medium having instructions stored thereon, that when executed by a processor cause the processor to perform operations, the operations comprising:
collecting a communication between a user and an artificial intelligence bot, wherein the communication comprises one or more of a video data, an audio data, and a telemetry data;
determining a sentiment associated with the communication using the one or more of the video data, the audio data, and the telemetry data;
determining a score associated with the sentiment;
determining a plurality of questions, each question associated with a difficulty level corresponding to a range associated with the score, the plurality of questions based on a user data associated with the user;
selecting a question from the plurality of questions using the score; and
providing the question to the artificial intelligence bot, wherein the artificial intelligence bot incorporates the question into a dialogue between the artificial intelligence bot and the user.

17. The non-transitory computer readable medium of claim 16, further comprising:
receiving an audio data over a real-time video call between the artificial intelligence bot and the user, wherein the audio data includes an answer and other audio data;
determining a second sentiment using the answer and the other audio data associated with the real-time video call;
selecting a second question from the plurality of questions, wherein a difficulty level of the second question corresponds to the second sentiment; and
communicating the second question in the dialogue over the real-time video call.

18. The non-transitory computer readable medium of claim 16, further comprising:
receiving an answer to the question over a real-time video call, wherein the video call includes a second video data;
determining a second sentiment using the second video data and the answer;
selecting a second question from the plurality of questions, wherein a difficulty level of the second question corresponds to the second sentiment; and
communicating the second question in the dialogue over the video call.

19. The non-transitory computer readable medium of claim 16, further comprising:
receiving a second communication over a real-time video call;
determining a second sentiment using the second communication;
selecting a second question from the plurality of questions, wherein a difficulty level of the second question corresponds to the second sentiment and is higher than the difficulty level of the question; and
communicating the second question in the dialogue over the real-time video call.

20. The non-transitory computer readable medium of claim 16, wherein the plurality of questions are based on content of at least one textual document associated with a user account.
